(19) United States
(12) Patent Application Publication
(10) Pub. No.: US 2025/0138488 A1
(43) Pub. Date: May 1, 2025

(54) STEMLESS OPERATION MECHANISM WITH A PREFERRED WATERPROOF FUNCTION

(71) Applicant: PixArt Imaging Inc., Hsin-Chu City (TW)

(72) Inventors: Sen-Huang Huang, Hsin-Chu City (TW); Ming Shun Manson Fei, Hsin-Chu City (TW); Cong-Jun XIA, Hsin-Chu City (TW); Gui-Ping SU, Hsin-Chu City (TW)

(73) Assignee: PixArt Imaging Inc., Hsin-Chu City (TW)

(21) Appl. No.: 18/914,302

(22) Filed: Oct. 14, 2024

Related U.S. Application Data
(60) Provisional application No. 63/593,244, filed on Oct. 26, 2023.

(30) Foreign Application Priority Data
Sep. 24, 2024 (CN) 202411331785.0

(51) Int. Cl. G04C 3/00

(52) U.S. Cl. CPC G04C 3/001

(57) ABSTRACT

A stemless operation mechanism includes a case, a first moving component, a second moving component and a detection module. The case includes a first accommodating area, a second accommodating area and a partition portion used to provide an airtight isolating function. The first moving component is movably disposed on the first accommodating area and includes a first magnetic unit. The second moving component is movably disposed on the second accommodating area and includes a second magnetic unit located on position corresponding to position of the first magnetic unit. The second magnetic unit is cooperated with the first magnetic unit to generate a magnetic attraction force or a magnetic repulsion force. The detection module is disposed adjacent to the second moving component, and adapted to detect a movement of the second moving component for determining an operation behavior applied for the first moving component.

### CROSS REFERENCE TO RELATED APPLICATIONS

This application claims the benefit of U.S. Provisional Application No. 63/593,244, filed on Oct. 26, 2023. The content of the application is incorporated herein by reference.

### BACKGROUND OF THE INVENTION

### 1. Field of the Invention

The present invention relates to a stemless operation mechanism, and more particularly, to a stemless operation mechanism applied to a watch and having a preferred waterproof function.

### 2. Description of the Prior Art

A conventional watch disposes a crown on the side of the case to adjust the date and time of the watch. The crown of the conventional watch uses a screw or other mechanical component to straighten into the case for connecting with the clockwork that controls the date and time; the user can press or rotate the crown, and the screw (and the related mechanical component) is driven by the crown to pull the clockwork inside the case. However, there is a gap formed between the screw (and the related mechanical component) and the case, and external liquid or dust may easily enter the case through the gap when the user operates the crown, thereby affecting stability and accuracy of the internal mechanism of the watch. Therefore, design of a stemless or rodless operating mechanism which provides a non-contact transmission function so that the product with the operating requirements such as rotation or pressing can have waterproof and dustproof effects is an important issue in the related mechanism design industry.

### SUMMARY OF THE INVENTION

The present invention provides a stemless operation mechanism applied to a watch and having a preferred waterproof function for solving above drawbacks.

According to the claimed invention, a stemless operation mechanism is applied to a watch and has a waterproof function. The stemless operation mechanism includes a case, a first moving component, a second moving component and a detection module. The case includes a first accommodating area, a second accommodating area and a partition portion. The partition portion is disposed between the first accommodating area and the second accommodating area to provide an airtight isolating function. The first moving component is movably disposed on the first accommodating area and includes a first magnetic unit. The second moving component is movably disposed on the second accommodating area and includes a second magnetic unit located on position corresponding to position of the first magnetic unit. The second magnetic unit is cooperated with the first magnetic unit to generate a magnetic attraction force or a magnetic repulsion force. The detection module is disposed adjacent to the second moving component, and adapted to detect a movement of the second moving component for determining an operation behavior applied for the first moving component.

According to the claimed invention, the detection module includes an optical detector, and a feature point is formed on a rotation shaft of the second moving component, and the optical detector detects position change of the feature point to acquire the movement of the second moving component. The detection module further includes an illumination light source adapted to project an illumination beam onto the rotation shaft.

According to the claimed invention, the first moving component is disposed on the first accommodating area in a rotatable manner, and a first rotation axis of the first moving component is straightened from the first accommodating area to the second accommodating area; or, the first moving component is disposed on the first accommodating area in a shiftable manner, and a size of the first moving component is smaller than a size of a wall of the first accommodating area adjacent to the second accommodating area, and a shifting direction of the first moving component is intersected with a planar normal vector of the wall; or, the first moving component is disposed on the first accommodating area in a rotatable manner, and a first rotation axis of the first moving component is intersected with a planar normal vector of a wall of the first accommodating area adjacent to the second accommodating area.

According to the claimed invention, the first magnetic unit is moved relative to the second magnetic unit within a constraint range in a rotational manner or in a reciprocating manner; or, the first moving component includes a plurality of first magnetic units, and the plurality of first magnetic units is sequentially moved close to and away from the second magnetic unit in accordance with rotation of the first moving component.

According to the claimed invention, the second moving component is disposed on the second accommodating area in a rotatable and shiftable manner, and a size of the second moving component is smaller than a size of a wall of the second accommodating area adjacent to the first accommodating area. The second magnetic unit is disposed on position aligning with a second rotation axis of the second moving component. Or, two magnetic poles of the first magnetic unit are respectively located on two opposite sides of a first rotation axis of the first moving component, and two magnetic poles of the second magnetic unit are respectively located on two opposite sides of a second rotation axis of the second moving component. Or, the first magnetic unit is located on a side of a first rotation axis of the first moving component, and the second magnetic unit is located on a side of a second rotation axis of the second moving component.

According to the claimed invention, the second moving component is disposed on the second accommodating area in a rotatable manner, and a second rotation axis of the second moving component is intersected with or parallel to a first rotation axis of the first moving component. Two magnetic poles of the second magnetic unit are respectively located on two opposite sides of the second rotation axis.

According to the claimed invention, the stemless operation mechanism further includes a resilient component disposed on the first accommodating area and engaged with the first moving component.

According to the claimed invention, the detection module is a mechanical switch, and the mechanical switch is triggered by the movement of the second moving component to output a control command. The mechanical switch includes two electrode connectors, or includes a push button with two electrodes.

According to the claimed invention, the second moving component further includes a third magnetic unit disposed on a rotation shaft of the second moving component pointing towards the detection module. The detection module includes a hall sensor, and the hall sensor detects change of a magnetic field generated by the third magnetic unit when the second moving component is shifted or rotated for acquiring the movement of the second moving component.

The stemless operation mechanism of the present invention can dispose the partition portion between the first accommodating area and the second accommodating area to provide the airtight isolating function in the case. The first moving component and the second moving component can be respectively disposed on the first accommodating area and the second accommodating area in the movable manner. The first moving component can be the dial of the watch, or can be connected with the crown; the second moving component can be straightened for being adjacent to the detection module. Each of the first moving component and the second moving component can include the first magnetic unit and the second magnetic unit, which are interacted to generate the magnetic attraction force or the magnetic repulsion force. When the user operates the dial or the crown, the stemless operation mechanism can utilize a non-contact force generated by the magnetic units to make the first moving component synchronously move the second moving component, and the detection module can immediately detect rotation parameters and/or pushing parameters of the dial or the crown, for determining the operation behavior applied by the user. Comparing to the prior art, the stemless operation mechanism of the present invention can have advantages of simple structure, low manufacturing cost and preferred installation accuracy, and provide the waterproof and dustproof function.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an appearance diagram of parts of a watch having a stemless operation mechanism according to an embodiment of the present invention.

FIG. 2 is a structural diagram of the stemless operation mechanism applied for the watch according to the embodiment of the present invention.

FIG. 3 is a sectional view of the stemless operation mechanism according to a first embodiment of the present invention.

FIG. 4 is a sectional view of the stemless operation mechanism according to a second embodiment of the present invention.

FIG. 5 is an appearance diagram of the watch having the stemless operation mechanism according to a third embodiment of the present invention.

FIG. 6 is a sectional view of the stemless operation mechanism according to the third embodiment of the present invention.

FIG. 7 is a sectional view of the stemless operation mechanism according to a fourth embodiment of the present invention.

FIG. 8 is an appearance diagram of the stemless operation mechanism according to a fifth embodiment of the present invention.

FIG. 9 is a sectional view of the stemless operation mechanism according to the fifth embodiment of the present invention.

FIG. 10 is a sectional view of the stemless operation mechanism according to a sixth embodiment of the present invention.

### DETAILED DESCRIPTION

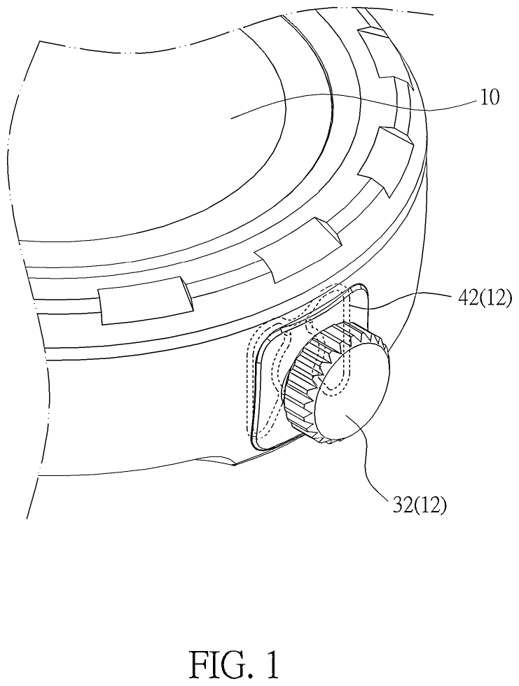

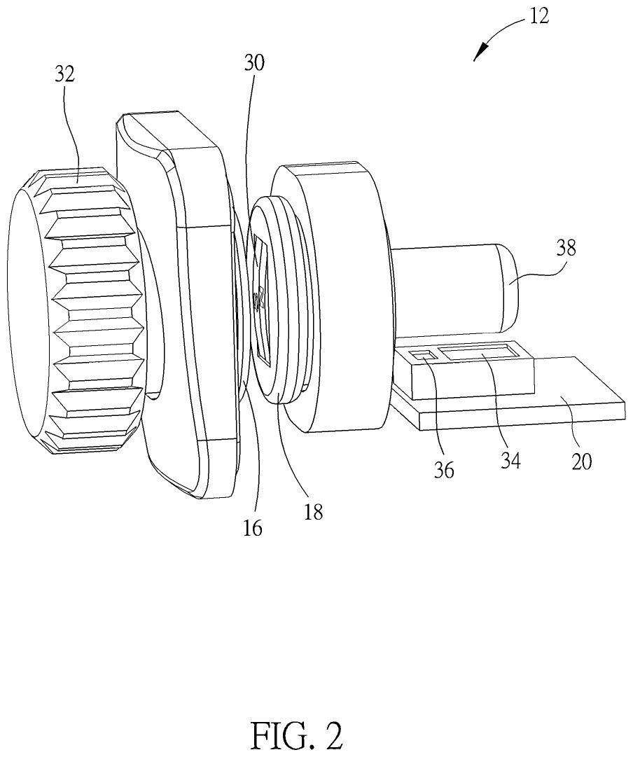

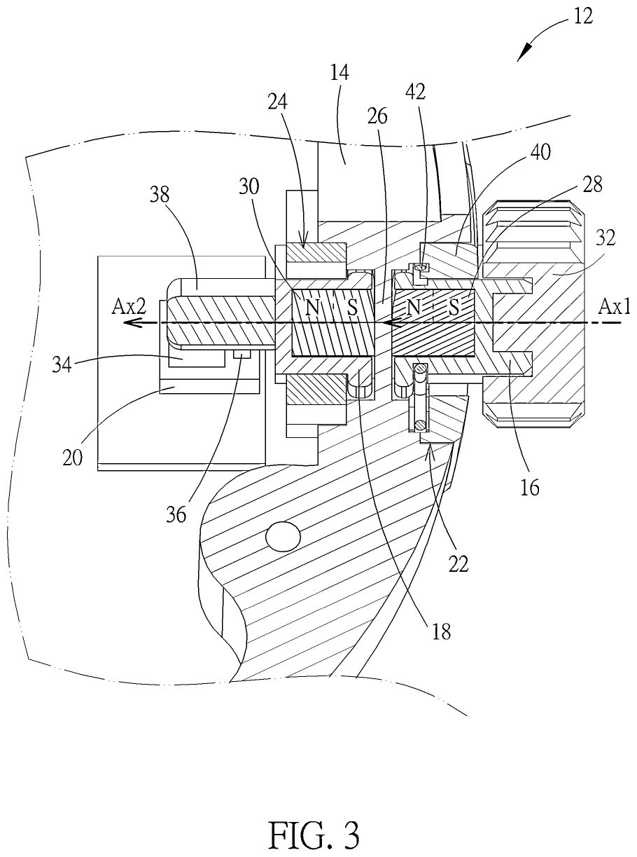

Please refer to FIG. 1 to FIG. 3. FIG. 1 is an appearance diagram of parts of a watch 10 having a stemless operation mechanism 12 according to an embodiment of the present invention. FIG. 2 is a structural diagram of the stemless operation mechanism 12 applied for the watch 10 according to the embodiment of the present invention. FIG. 3 is a sectional view of the stemless operation mechanism 12 according to a first embodiment of the present invention. The stemless operation mechanism 12 can have a preferred waterproof and dustproof function, and can prevent liquid or dust from entering the watch 10 and causing damage of internal components when being applied to the watch 10. The stemless operation mechanism 12 can include a case 14, a first moving component 16, a second moving component 18 and a detection module 20. The first moving component 16 and the second moving component 18 can be respectively disposed on the outside and inside of the case 14 in an airtight isolating manner. When the user operates the first moving component 16, the second moving component 18 can be moved due to motion of the first moving component 16, and the detection module 20 can detect a movement of the second moving component 18 to determine an operation behavior applied for the first moving component 16 by the user.

As the first embodiment shown in FIG. 3, the case 14 can include a first accommodating area 22, a second accommodating area 24 and a partition portion 26. The partition portion 26 can be disposed between the first accommodating area 22 and the second accommodating area 24 to provide an airtight isolating function. The first moving component 16 can be movably disposed on the first accommodating area 22, and have a first magnetic unit 28. The second moving component 18 can be movably disposed on the second accommodating area 24, and have a second magnetic unit 30 located on position corresponding to position of the first magnetic unit 28. The second magnetic unit 30 can be cooperated with the first magnetic unit 28 to generate a magnetic attraction force or a magnetic repulsion force. A crown 32 can be disposed on an end of the first moving component 16 opposite to the second moving component 18. When the user rotates or pushes the crown 32, the first moving component 16 can be directly driven by the crown 32, and the magnetic attraction force or magnetic repulsion force generated between the first magnetic unit 28 and the second magnetic unit 30 can move the second moving component 18 in accordance with motion of the first moving component 16.

The detection module 20 can be disposed on position adjacent to the second moving component 18. The detection module 20 can optionally only include an optical detector 34, or both include the optical detector 34 and an illumination light source 36. The illumination light source 36 can project an illumination beam onto a rotation shaft 38 of the second moving component 18. One or plural feature points (which are not marked in the figures) can be depression or protrusion irregularly formed on the rotation shaft 38. The optical detector 34 can receive a reflection beam generated by the illumination beam projected onto the feature point of the rotation shaft 38, and analyze the reflection beam to detect position change of the feature point, so as to acquire the movement of the second moving component 18.

In the first embodiment, the first moving component 16 can be disposed on the first accommodating area 22 in a rotatable manner, and a first rotation axis Ax1 of the first moving component 16 can be straightened from the first accommodating area 22 towards the second accommodating area 24. The watch 10 may optionally include a crown supporting component 40 disposed between the case 14 and the stemless operation mechanism 12. A resilient component 42 can be located on the first accommodating area 22, and engaged with the crown supporting component 40 and the first moving component 16 for stably holding the first moving component 16 via an auxiliary supporting function. The second moving component 18 can be disposed on the second accommodating area 24 in the rotatable manner. In addition, two magnetic poles N and S of the first magnetic unit 28 can be both located on a side of the first rotation axis Ax1 of the first moving component 16, and two magnetic poles N and S of the second magnetic unit 30 can be both located on a side of a second rotation axis Ax2 of the second moving component 18.

When the user rotates the crown 32 to drive rotation of the first moving component 16, at least one of the magnetic poles N and S of the first magnetic unit 28 can be rotated around the first rotation axis Ax1, and the magnetic attraction force can be preferably utilized to rotate the corresponding magnetic pole S or N of the second magnetic unit 30 around the second rotation axis Ax2; in other possible embodiment, the magnetic repulsion force may be utilized to rotate the corresponding magnetic pole N or S of the second magnetic unit 30 around the second rotation axis Ax2. The second moving component 18 can be rotated around the second rotation axis Ax2 in accordance with rotation of the second magnetic unit 30; in the meantime, the detection module 20 can detect the position change of the feature point on the rotation shaft 38 to acquire motion parameters of the crown 32, such as a rotary direction, a rotary angle and/or a rotary speed, so as to determine an operation behavior applied for the crown 32 by the user.

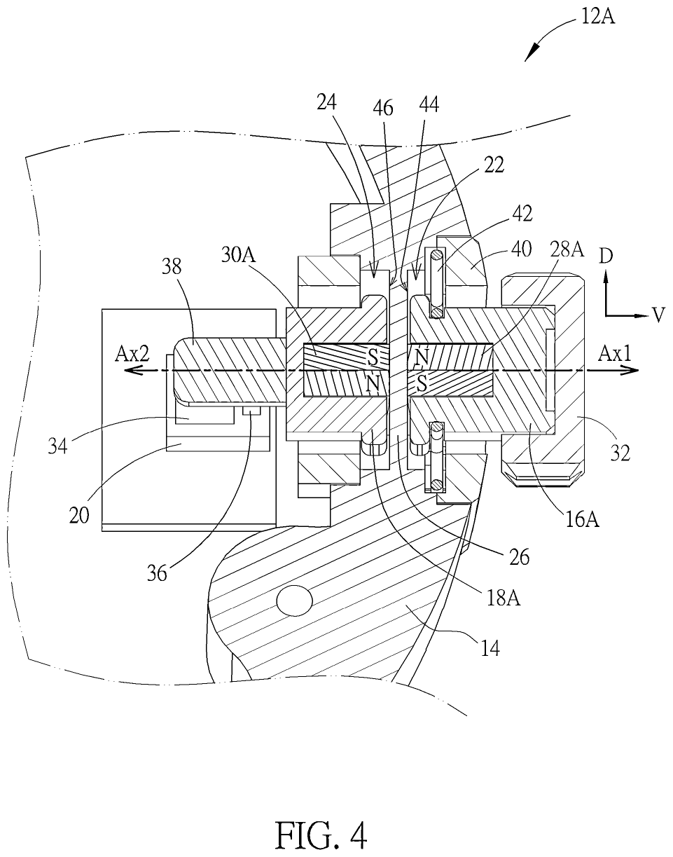

Please refer to FIG. 4. FIG. 4 is a sectional view of the stemless operation mechanism 12A according to a second embodiment of the present invention. In the second embodiment, elements having the same numerals as ones of the first embodiment can have the same structures and functions, and a detailed description is omitted herein for simplicity. A size of the first moving component 16A of the stemless operation mechanism 12A can be smaller than a size of a wall 44 of the first accommodating area 22 adjacent to the second accommodating area 24, and the first moving component 16A can be disposed on the first accommodating area 22 in the rotatable and shiftable manner. A size of the second moving component 18A of the stemless operation mechanism 12A can be smaller than a size of a wall 46 of the second accommodating area 24 adjacent to the first accommodating area 22, and the second moving component 18A can be disposed on the second accommodating area 24 in the rotatable and shiftable manner. Besides, two magnetic poles N and S of the first magnetic unit 28A of the stemless operation mechanism 12A can be preferably located two opposite sides of the first rotation axis Ax1 of the first moving component 16A; the second magnetic unit 30A can be disposed on position aligning with the second rotation axis Ax2 of the second moving component 18A, and two magnetic poles N and S of the second magnetic unit 30A can be respectively located on two opposite sides of the second rotation axis Ax2 of the second moving component 18A, and the second moving component 18A can be driven to rotate and shift accordingly.

The first moving component 16A can be rotated around the first rotation axis Ax1 and shifted relative to the wall 44. A shifting direction D of the first moving component 16A can be intersected with (or perpendicular to) a planar normal vector V of the wall 44. The resilient component 42 can provide a recovering function in the shifting direction D, so that the first magnetic unit 28A can be moved relative to the second magnetic unit 30A within a constraint range in a rotational manner and/or in a reciprocating manner. Two magnetic poles N and S of the first magnetic unit 28A can respectively align with two magnetic poles S and N of the second magnetic unit 30A for generating the magnetic attraction force; practical application of the first magnetic unit 28A and the second magnetic unit 30A is not limited to the foresaid embodiment. For example, two magnetic poles N and S of the first magnetic unit 28A may align with the magnetic poles N and S of the second magnetic unit 30A to generate the magnetic repulsion force. When the user rotates or shifts the crown 32, the first moving component 16A and the first magnetic unit 28A can be moved in accordance with motion of the crown 32, and the magnetic attraction force or the magnetic repulsion force generated between the first magnetic unit 28A and the second magnetic unit 30A can drive the second moving component 18A and the second magnetic unit 30A to generate synchronous motion; in the meantime, the detection module 20 can detect the position change of the feature point on the rotation shaft 38 to acquire behavior parameters of rotation or shifting of the crown 32.

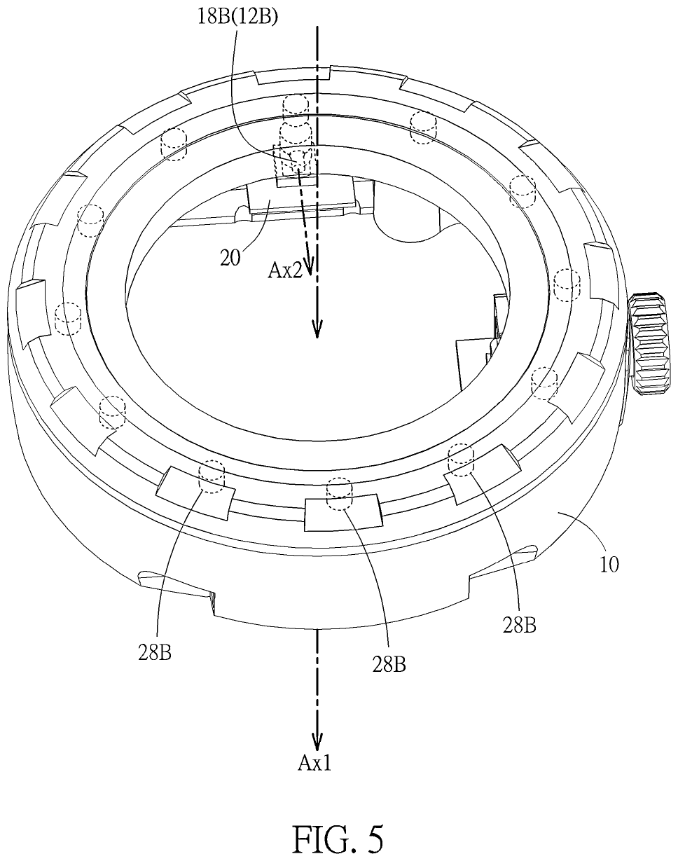

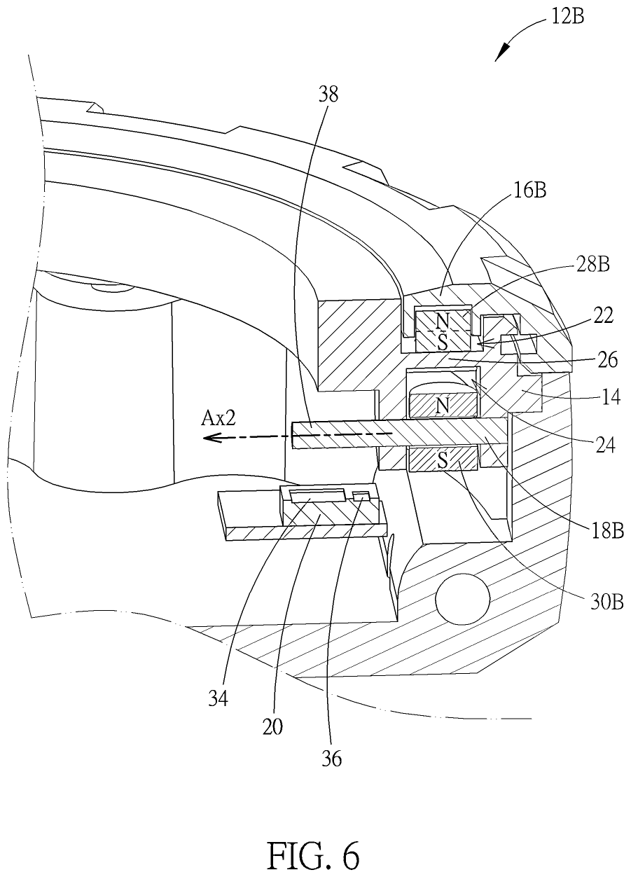

Please refer to FIG. 5 and FIG. 6. FIG. 5 is an appearance diagram of the watch 10 having the stemless operation mechanism 12B according to a third embodiment of the present invention. FIG. 6 is a sectional view of the stemless operation mechanism 12B according to the third embodiment of the present invention. In the third embodiment, elements having the same numerals as ones of the foresaid embodiment can have the same structures and functions, and the detailed description is omitted herein for simplicity. The first moving component 16B of the stemless operation mechanism 12B can be designed as a dial of the watch 10, and can be disposed on the first accommodating area 22 in the rotatable manner; the first rotation axis Ax1 of the first moving component 16B can be straightened from the first accommodating area 22 towards the second accommodating area 24. The second moving component 18B can be disposed on the second accommodating area 24 in the rotatable manner, and the second rotation axis Ax2 of the second moving component 18B can be intersected with (or perpendicular to) the first rotation axis Ax1 of the first moving component 16B.

The first moving component 16B can include a plurality of first magnetic units 28B respectively disposed on several sections of the first moving component 16B of the ring structure. Two magnetic poles N and S of the second magnetic unit 30B can be respectively disposed on two opposite sides of the second rotation axis Ax2. The magnetic pole N of the first magnetic unit 28B can face towards the magnetic pole N of the second magnetic unit 30B to generate the magnetic repulsion force, or the magnetic pole S of the first magnetic unit 28B can face towards the magnetic pole N of the second magnetic unit 30B to generate the magnetic attraction force; practical application of the first magnetic unit 28B and the second magnetic unit 30B can depend on an actual demand. Therefore, when the user pushes the first moving component 16B to rotate around the first rotation axis Ax1, the plurality of first magnetic units 28B can be sequentially moved close to and away from the second magnetic unit 30B in accordance with rotation of the first moving component 16B, and the second magnetic unit 30B and the second moving component 18B can be rotated accordingly; in the meantime, the detection module 20 can detect the position change of the feature point on the rotation shaft 38 to acquire the motion parameters of the first moving component 16B, such as the rotary direction, the rotary angle and/or the rotary speed, for determining the operation behavior applied for the dial (which means the first moving component 16B) by the user.

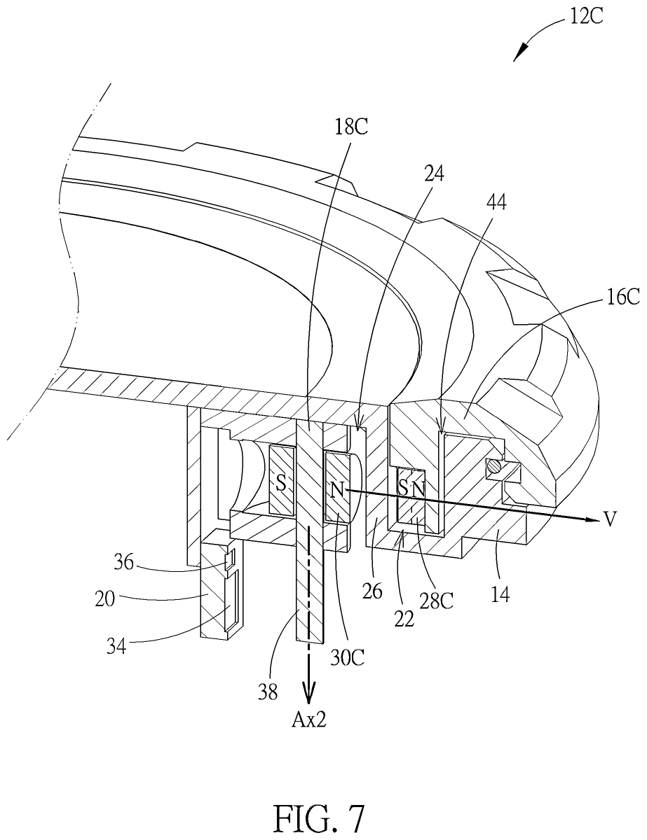

Please refer to FIG. 5 to FIG. 7. FIG. 7 is a sectional view of the stemless operation mechanism 12C according to a fourth embodiment of the present invention. In the fourth embodiment, elements having the same numerals as ones of the foresaid embodiment can have the same structures and functions, and the detailed description is omitted herein for simplicity. The first moving component 16C of the stemless operation mechanism 12C can be disposed on the first accommodating area 22 in the rotatable manner, and the first rotation axis Ax1 (which can be shown in FIG. 5) of the first moving component 16C can be intersected with the planar normal vector V of the wall 44 of the first accommodating area 22 adjacent to the second accommodating area 24. The second moving component 18C can be disposed on the second accommodating area 24 in the rotatable manner, and the second rotation axis Ax2 of the second moving component 18C can be parallel to the first rotation axis Ax1 of the first moving component 16C.

The first moving component 16C can include a plurality of first magnetic units 28C respectively disposed on several sections of the first moving component 16C of the ring structure, which is similar to the first magnetic unit 28B shown in FIG. 5. Two magnetic poles N and S of the second magnetic unit 30C can be respectively disposed on two opposite sides of the second rotation axis Ax2. The magnetic pole N of the first magnetic unit 28C can face towards the magnetic pole N of the second magnetic unit 30C to generate the magnetic repulsion force, or the magnetic poles S of the first magnetic unit 28C can face towards the magnetic pole N of the second magnetic unit 30C to generate the magnetic attraction force; practical application of the first magnetic unit 28C and the second magnetic unit 30C can depend on an actual demand. Thus, when the user pushes the first moving component 16C to rotate around the first rotation axis Ax1, the plurality of first magnetic units 28C can be sequentially moved close to and away from the second magnetic unit 30C in accordance with rotation of the first moving component 16C, and the second magnetic unit 30C and the second moving component 18C can be rotated accordingly; in the meantime, the detection module 20 can detect the position change of the feature point on the rotation shaft 38 to acquire the motion parameters of the first moving component 16C, such as the rotary direction, the rotary angle and/or the rotary speed, for determining the operation behavior applied for the dial (which means the first moving component 16C) by the user.

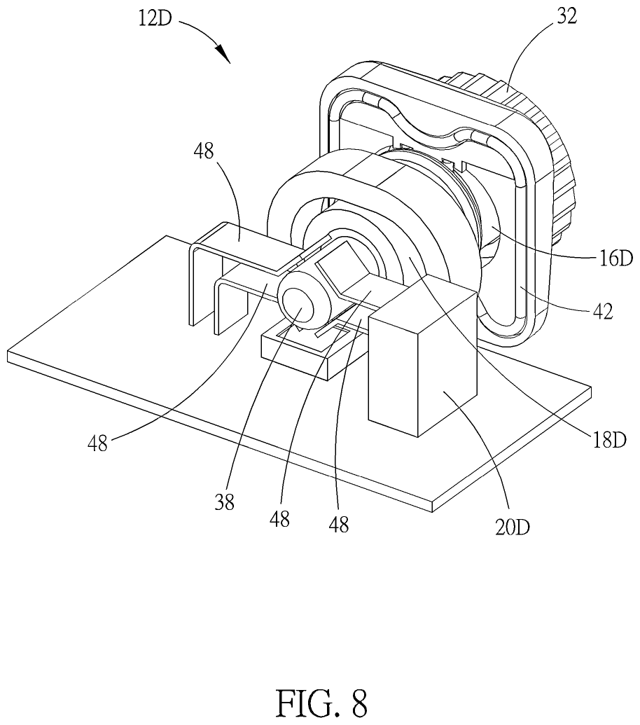

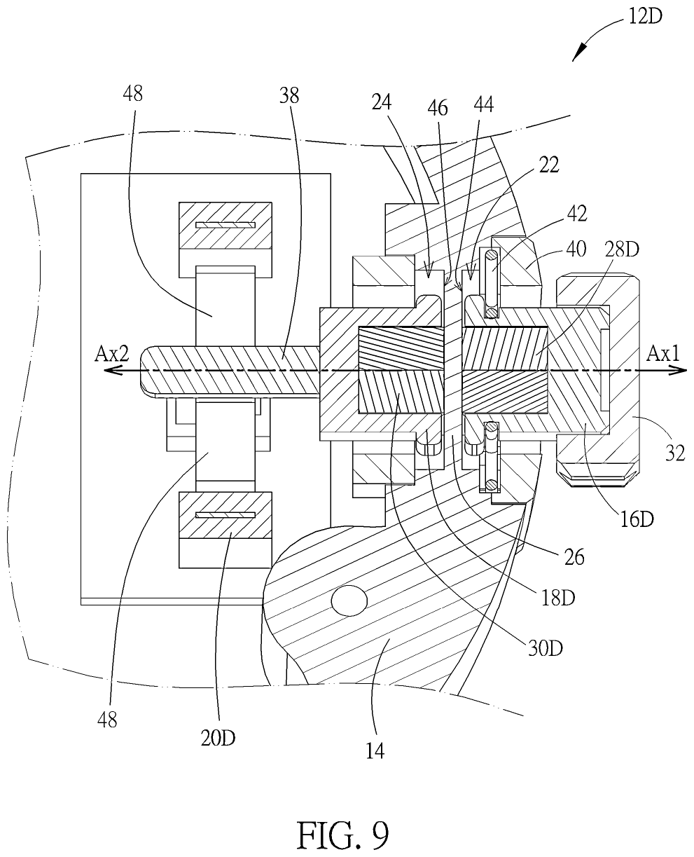

Please refer to FIG. 8 and FIG. 9. FIG. 8 is an appearance diagram of the stemless operation mechanism 12D according to a fifth embodiment of the present invention. FIG. 9 is a sectional view of the stemless operation mechanism 12D according to the fifth embodiment of the present invention. In the fifth embodiment, elements having the same numerals as ones of the foresaid embodiment can have the same structures and functions, and the detailed description is omitted herein for simplicity. A size of the first moving component 16D of the stemless operation mechanism 12D can be smaller than the size of the wall 44 of the first accommodating area 22 adjacent to the second accommodating area 24. The first moving component 16D can be disposed on the first accommodating area 22 in the rotatable and shiftable manner. A size of the second moving component 18D of the stemless operation mechanism 12D can be smaller than the size of the wall 46 of the second accommodating area 24 adjacent to the first accommodating area 22. The second moving component 18D can be disposed on the second accommodating area 24 in the rotatable and shiftable manner. Moreover, two magnetic poles N and S of the first magnetic unit 28D of the stemless operation mechanism 12D can be respectively disposed on two opposite sides of the first rotation axis Ax1 of the first moving component 16D; the second magnetic unit 30D can be disposed on position aligning with the second rotation axis Ax2 of the second moving component 18D, and two magnetic poles N and S of the second magnetic unit 30D can be respectively located on two opposite sides of the second rotation axis Ax2 of the second moving component 18D, for effectively driving rotation and shifting of the second moving component 18D.

That is, the first moving component 16D can be rotated around the first rotation axis Ax1, and/or can be shifted relative to the wall 44. The resilient component 42 can provide the recovering function in the shifting direction D, and therefore the first magnetic unit 28D can be moved relative to the second magnetic unit 30D within the constraint range in the rotational manner and/or in the reciprocating manner. The detection module 20D can be a mechanical switch, which includes two electrode connectors 48, or includes a push button with two electrodes (which is shown in the figures and can be set on position similar to the electrode connectors 48). When the user rotates or shifts the crown 32, the first moving component 16D and the first magnetic unit 28D can be moved in accordance with motion of the crown 32, and the magnetic attraction force or the magnetic repulsion force generated between the first magnetic unit 28D and the second magnetic unit 30D can drive the second moving component 18D and the second magnetic unit 30D to generate the synchronous motion; in the meantime, the detection module 20D can be triggered to output the control command when the second moving component 18D touches the two electrode connectors 48 of one of the plurality of electrode sets and causes a short circuit.

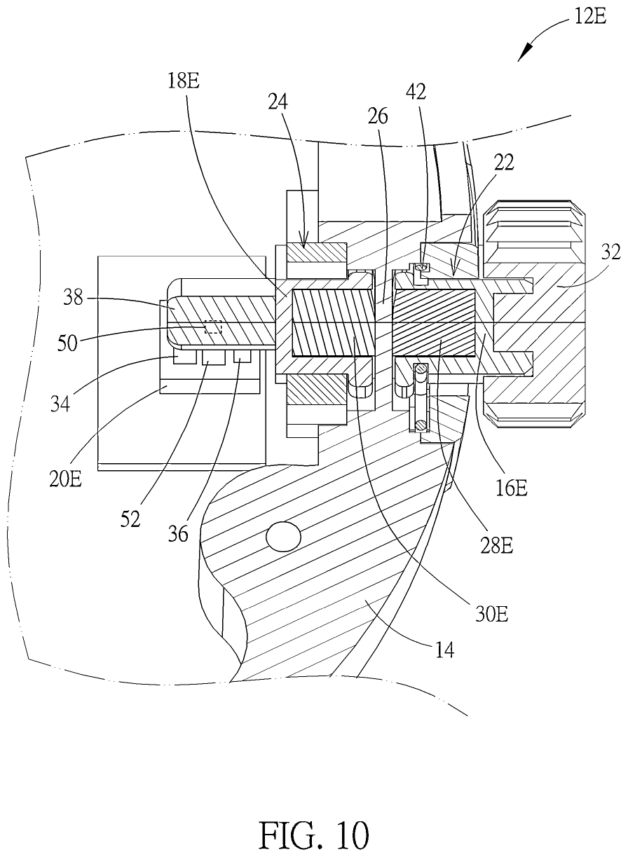

Please refer to FIG. 10. FIG. 10 is a sectional view of the stemless operation mechanism 12E according to a sixth embodiment of the present invention. In the sixth embodiment, elements having the same numerals as ones of the foresaid embodiment can have the same structures and functions, and the detailed description is omitted herein for simplicity. The second moving component 18E of the stemless operation mechanism 12E can include the second magnetic unit 30E and a third magnetic unit 50. Position of the second magnetic unit 30E can correspond to position of the first magnetic unit 28E of the first moving component 16E, and the third magnetic unit 50 can be disposed on the rotation shaft 38 of the second moving component 18E pointing towards the detection module 20E. The detection module 20E can further include a hall sensor 52. When the user rotates the crown 32 to drive rotation of the first moving component 16E and the first magnetic unit 28E, the second moving component 18E and the second magnetic unit 30E and the third magnetic unit 50 can be rotated accordingly. The hall sensor 52 of the detection module 20E can detect change of a magnetic field in response to the rotation or shifting of the third magnetic unit 50, and the optical detector 34 and the illumination light source 36 of the detection module 20E can further detect the position change of the feature point on the rotation shaft 38, so as to acquire the movement of the second moving component 18E and determine the operation behavior applied for the crown 32 by the user.

In conclusion, the stemless operation mechanism of the present invention can dispose the partition portion between the first accommodating area and the second accommodating area to provide the airtight isolating function in the case. The first moving component and the second moving component can be respectively disposed on the first accommodating area and the second accommodating area in the movable manner. The first moving component can be the dial of the watch, or can be connected with the crown; the second moving component can be straightened for being adjacent to the detection module. Each of the first moving component and the second moving component can include the first magnetic unit and the second magnetic unit, which are interacted to generate the magnetic attraction force or the magnetic repulsion force. When the user operates the dial or the crown, the stemless operation mechanism can utilize a non-contact force generated by the magnetic units to make the first moving component synchronously move the second moving component, and the detection module can immediately detect rotation parameters and/or pushing parameters of the dial or the crown, for determining the operation behavior applied by the user. Comparing to the prior art, the stemless operation mechanism of the present invention can have advantages of simple structure, low manufacturing cost and preferred installation accuracy, and provide the waterproof and dustproof function.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A stemless operation mechanism applied to a watch and having a waterproof function, the stemless operation mechanism comprising:
a case comprising a first accommodating area, a second accommodating area and a partition portion, the partition portion being disposed between the first accommodating area and the second accommodating area to provide an airtight isolating function;
a first moving component movably disposed on the first accommodating area and comprising a first magnetic unit;
a second moving component movably disposed on the second accommodating area and comprising a second magnetic unit located on position corresponding to position of the first magnetic unit, the second magnetic unit being cooperated with the first magnetic unit to generate a magnetic attraction force or a magnetic repulsion force; and
a detection module disposed adjacent to the second moving component, and adapted to detect a movement of the second moving component for determining an operation behavior applied for the first moving component.

2. The stemless operation mechanism of claim 1, wherein the detection module comprises an optical detector, a feature point is formed on a rotation shaft of the second moving component, and the optical detector detects position change of the feature point to acquire the movement of the second moving component.

3. The stemless operation mechanism of claim 2, wherein the detection module further comprises an illumination light source adapted to project an illumination beam onto the rotation shaft.

4. The stemless operation mechanism of claim 1, wherein the first moving component is disposed on the first accommodating area in a rotatable manner, a first rotation axis of the first moving component is straightened from the first accommodating area to the second accommodating area

5. The stemless operation mechanism of claim 1, wherein the first moving component is disposed on the first accommodating area in a shiftable manner, a size of the first moving component is smaller than a size of a wall of the first accommodating area adjacent to the second accommodating area, and a shifting direction of the first moving component is intersected with a planar normal vector of the wall.

6. The stemless operation mechanism of claim 1, wherein the first moving component is disposed on the first accommodating area in a rotatable manner, a first rotation axis of the first moving component is intersected with a planar normal vector of a wall of the first accommodating area adjacent to the second accommodating area.

7. The stemless operation mechanism of claim 1, wherein the first magnetic unit is moved relative to the second magnetic unit within a constraint range in a rotational manner or in a reciprocating manner.

8. The stemless operation mechanism of claim 1, wherein the first moving component comprises a plurality of first magnetic units, the plurality of first magnetic units is sequentially moved close to and away from the second magnetic unit in accordance with rotation of the first moving component.

9. The stemless operation mechanism of claim 1, wherein the second moving component is disposed on the second accommodating area in a rotatable and shiftable manner, a size of the second moving component is smaller than a size of a wall of the second accommodating area adjacent to the first accommodating area.

10. The stemless operation mechanism of claim 9, wherein the second magnetic unit is disposed on position aligning with a second rotation axis of the second moving component.

11. The stemless operation mechanism of claim 9, wherein two magnetic poles of the first magnetic unit are respectively located on two opposite sides of a first rotation axis of the first moving component, and two magnetic poles of the second magnetic unit are respectively located on two opposite sides of a second rotation axis of the second moving component.

12. The stemless operation mechanism of claim 9, wherein the first magnetic unit is located on a side of a first rotation axis of the first moving component, and the second magnetic unit is located on a side of a second rotation axis of the second moving component.

13. The stemless operation mechanism of claim 1, wherein the second moving component is disposed on the second accommodating area in a rotatable manner, a second rotation axis of the second moving component is intersected with or parallel to a first rotation axis of the first moving component.

14. The stemless operation mechanism of claim 13, wherein two magnetic poles of the second magnetic unit are respectively located on two opposite sides of the second rotation axis.

15. The stemless operation mechanism of claim 1, wherein the stemless operation mechanism further comprises a resilient component disposed on the first accommodating area and engaged with the first moving component.

16. The stemless operation mechanism of claim 1, wherein the detection module is a mechanical switch, the mechanical switch is triggered by the movement of the second moving component to output a control command.

17. The stemless operation mechanism of claim 16, wherein the mechanical switch comprises two electrode connectors, or comprises a push button with two electrodes.

18. The stemless operation mechanism of claim 1, wherein the second moving component further comprises a third magnetic unit disposed on a rotation shaft of the second moving component pointing towards the detection module, the detection module comprises a hall sensor, and the hall sensor detects change of a magnetic field generated by the third magnetic unit when the second moving component is shifted or rotated for acquiring the movement of the second moving component.
